(19) United States
(12) Patent Application Publication
(10) Pub. No.: US 2025/0334697 A1
(43) Pub. Date: Oct. 30, 2025

(54) System and Methods for Compact Photonic Time Resolution

(71) Applicant: Andrew GRIFFIS, Tucson, AZ (US)

(72) Inventor: Andrew GRIFFIS, Tucson, AZ (US)

(21) Appl. No.: 18/586,990

(22) Filed: Feb. 26, 2024

Related U.S. Application Data
(60) Provisional application No. 63/448,273, filed on Feb. 25, 2023.

(51) Int. Cl. G01S 17/894; G01S 7/481; G01S 7/4861; G01S 7/489

(52) U.S. Cl. CPC G01S 17/894; G01S 7/4816; G01S 7/4861; G01S 7/489

(57) ABSTRACT

Systems and methods are provided for time resolution of signals produced by the emission of energy. More particularly, systems and methods are provided for measuring distance using photons propagating in a scattering medium to produce multi-dimensional, measurements of objects in a media and/or the media itself by virtue of the character of light spatially scattered and absorbed in the media resulting from the transmission of light into the media, such transmitted light having some temporal character that distinguishes it from background light, e.g., ambient sources. A method for obtaining terrestrial LiDAR data generally includes: providing a LiDAR system moving traverse to a ground canopy; emitting light pulses from the LiDAR system toward the ground canopy and terrain such that the light pulses reflect therefrom; and receiving the reflected light pulses at the LiDAR system; wherein the LiDAR system includes a monolithic module comprising a photonic device, a sampling module, a digitizing module, and a readout integrated circuit (ROIC).

### CROSS-REFERENCE TO RELATED APPLICATIONS

The present application claims priority to U.S. Prov. Pat. No. 63/448,273, filed Feb. 25, 2023, the entire contents of which are hereby incorporated by reference.

### TECHNICAL FIELD

The present subject matter relates to the technical field of imaging with integrated circuits. More particularly, the present subject matter relates to time-resolved imaging, e.g., LiDAR (light detection and ranging), for the purpose of observing the evolution of physical phenomena with multi-dimensional data, e.g., images or ensembles thereof. More particularly, the present subject matter relates to flash LiDAR for three-dimensional imaging, e.g., two spatial dimensions plus time, of objects located in media that contributes to the resultant imagery, e.g., objects located in scattering media.

### BACKGROUND

Systems and methods of the present disclosure address the interrogation of physical media with light. For the sake of illustration, the description below will often use marine LiDAR (LiDAR used for imaging in/through water), such as is used to image the topography of bodies of water, e.g., the practice of airborne bathymetry, in which temporally shaped light, e.g., a laser pulse, is transmitted into a body of water to produce reflected light from the water surface, water volume, objects in the water and the bottom of the body containing the water, e.g., the stream, lake or ocean, such light being resolved in space and time in order to reconstruct an image of the water volume, its contents and container. In the case of bathymetry, the objective of a LiDAR system for imaging the water volume is to distinguish the surface from the bottom and measure the distance between the two, separating out any objects or marine life lying between surface and bottom.

Present day practices for bathymetric marine LiDAR require wavelengths of light that can adequately penetrate water and the use of time resolving digitizers and scanners to provide useful spatial and temporal, e.g., depth, variation to satisfactorily resolve spatial features across the bottom of the body of water and the depth of the water, e.g., the distance between water surface and the bottom. Since water is a medium that reflects light, e.g., molecular water backscatter, it is necessary to measure, and time resolve the water volume reflected light not only at the surface and the bottom but at many points in between-the entire column of water must be measured and assessed to separate out surface and bottom and calculate the distance between them. This requires the use of high-speed digitizer electronics, e.g., nanosecond scale, that produce cost and complexity. When the LiDAR receiver is an integrated circuit device, this cost and complexity manifest themselves in terms of heat that must be dissipated (heat corresponding roughly to speed) and area that is consumed by the relatively complex analog to digital converter electronics. These two factors encourage the construction of integrated circuit LiDAR receivers having a minimum number of elements.

Further, since the water is a scattering medium, the scattering produces loss of spatial resolution, e.g., “blur”, that reduces the intensity of the received light and reduces the information available for objects in the water that occlude light between surface and bottom, due often to under sampling of the medium due to scanner spatial gaps (“holidays”) or the non-coincidence of space and time between successive samples across an object-the surface wave phenomena could for instance, refract light differently at different points in space and time, e.g., the so-called “swimming pool effect”. To mitigate such spatial artifacts of the medium, e.g., water, it is advantageous to simultaneously range resolve an entire region, e.g., an object and its context in a multiplicity of pixels, to be able to mitigate, correct or correctly interpret backscattered light that is spatially and temporally resolved.

As a result of these and other characteristics of imaging with light in scattering media, it is advantageous to combine high speed temporal sampling with multiple pixels of spatial sampling to observe the light reflected from a scattering medium from a single transmission, e.g., pulse, of light into the medium. This combination in which an entire “cube” of data is produced, can be described as full waveform flash LiDAR—LiDAR for which a multi pixel spatial region is imaged while simultaneously resolving temporally the temporal behavior of backscattered light at each pixel.

One example prior art approach can be found in U.S. Pat. No. 7,206,062, which describes a system with an analog sampling scheme and a ROIC form applied to infrared signaling, rather than a monolithic approach to LiDAR imaging.

Toward that end, the present invention is an architecture for an integrated circuit receiver design that permits such flash LiDAR behavior without the complexity of high-speed digitization, e.g., nanosecond analog to digital converter sampling, at each pixel in the multi pixel device, e.g., focal plane array of high-speed photodetectors.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description that is presented later. While embodiments of the invention will often be described in the context of imaging within a water medium, it will be understood that the range of embodiments is not so limited, and that the described techniques may be used in a variety of liquids and scattering media.

The present invention generally relates to the time resolution of signals produced by the emission of energy. More particularly, the present invention relates to the system for measuring distance using photons propagating in a scattering medium to produce multi-dimensional, e.g., two or more dimensions, measurements of objects in that media and/or the media itself by virtue of the character of light spatially scattered and absorbed in the media resulting from the transmission of light into the media, such transmitted light having some temporal character that distinguishes it from background light, e.g., ambient sources. It is understood that the multiple dimensions need not be restricted to spatial dimensions but can represent or embody other physical observables based on the mapping of individual picture elements (pixels) or temporal phenomena onto the observation medium.

### BRIEF DESCRIPTION OF THE DRAWINGS

FIG. 1 is an illustration of three common geometries of time resolved imaging systems;

FIG. 2 is a block diagram illustrating airborne full waveform LiDAR;

FIG. 3 is a block diagram illustrating an embodiment of a single pixel architecture;

FIG. 4 is a block diagram illustrating an embodiment of the single pixel architecture in which the N channel sampling and connectivity of the APD are shown explicitly;

FIG. 5 is a block diagram illustrating an embodiment of the single pixel architecture in which a first return is used to trigger a full waveform sampling;

FIG. 6 is a block diagram of an embodiment having an array of single pixel flash LiDAR elements, including a 2D array containing pixels related to the pixel illustration that follows;

FIG. 7 is a block diagram of an embodiment having an array of single pixel flash LiDAR accompanied by a distribution of trigger elements;

FIG. 8 is a block diagram illustrating an embodiment of variable bin size accomplished with sampler specific serialized time delay elements T_N and an embodiment of variable dynamic range accomplished with sampler specific charge storage elements C_N;

FIG. 9 is a block diagram illustrating an embodiment of substrate gain modulation (general, synchronous, FMCW orientation, PLL or phase detector in pixel);

FIG. 10 is a block diagram illustrating an embodiment of variable bin size accomplished with sampler specific gain modulation derived time delay elements (trigger on the amplitude or phase of a bias modulation signal); and

FIG. 11 is a block diagram illustrating an embodiment of synchronous demodulation using the sampled data.

### DETAILED DESCRIPTION

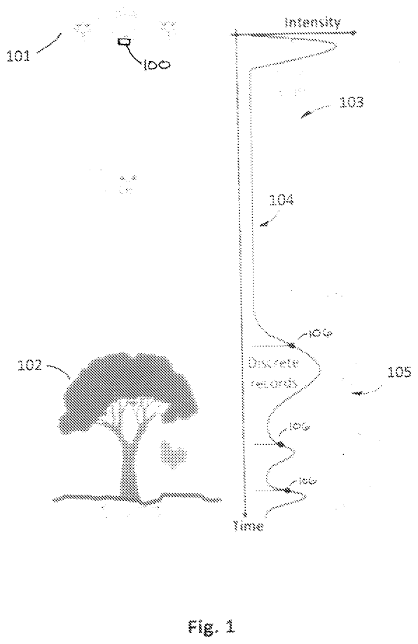

Referring now to FIG. 1, there is shown a method for obtaining terrestrial LiDAR data such that three-dimensional terrain structure can be observed. In general, the method includes a LiDAR system carried by an aircraft 101 that is flying to traverse a ground canopy 102, e.g., trees and other features beneath it. The LiDAR system uses an emitted pulse of light 103 that propagates from the aircraft 101 through the air 104 and reflects or backscatters from the uppermost part of the canopy 105 and other portions of the ground cover and ground or terrain, the path of the light and its backscattered shape being indicated by a line. The beam has a divergence and footprint as illustrated. This method, in which the backscattered light is received and digitized as a continuous temporal waveform, suggested by the line having a shape that corresponds to backscattered feature amplitudes, is called full waveform LiDAR. The alternative to full waveform LiDAR is to receive and digitize only the parts of the waveform that have statistically significant amplitudes, e.g., the “peaks” (e.g., discrete records 106), a practice that is most effective when the only objects in the propagation media, e.g., the air, reflect significantly, such that one can obtain the salient object distances and amplitudes for a much smaller set of data points. Significantly, the present invention supports such full waveform LiDAR methods.

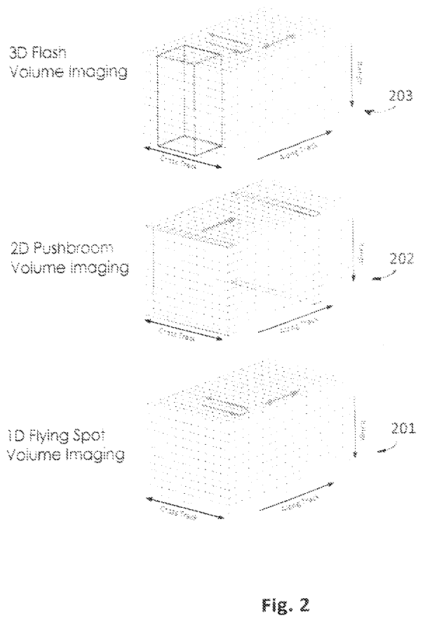

Referring now to the figures in more detail, in FIG. 2 there are shown three geometries commonly used for producing full waveform LiDAR data for use in 3D imaging. Beginning at the bottom of the figure, a commonly used LiDAR geometry is a pencil beam LiDAR 201, so-named because the projected laser light forms a narrow pencil-like distribution of light akin to the laser pointer “beam” commonly used in business presentations. This is the geometry of LiDAR implied by the airborne system illustrated in FIG. 1, wherein each pulse of light emitted by the laser produces a one-dimensional array of backscattered amplitudes whose sample times locate the amplitudes in space, e.g., the distance between LiDAR transmitter and (full waveform) receiver. If an additional dimension is added to the projected laser light such that the laser is diverged into a line perpendicular (or transverse) to the direction of light propagation and this line is received and time resolved at multiple points along the line such that a one-dimensional array of backscattered amplitudes is produced at each of the multiple points along the line, then a so-called “fan beam” LiDAR geometry 202 is produced for which each pulse of the laser produces a two-dimension range-azimuth image, where the azimuthal direction corresponds to the direction perpendicular to light propagation. If a third dimension is added to the projected laser light such that the laser is diverged into two dimensions into a region, e.g., a rectangle, and the LiDAR receiver is configured so as to receive and time resolve at two-dimensional array of points in the rectangular region such that each of the array points produces a corresponding one-dimensional array of backscattered amplitudes, then a full waveform “flash” LiDAR image is produced that is a cube of data 203. The present invention enables novel means and methods for obtaining such flash LiDAR data in a compact and efficient manner.

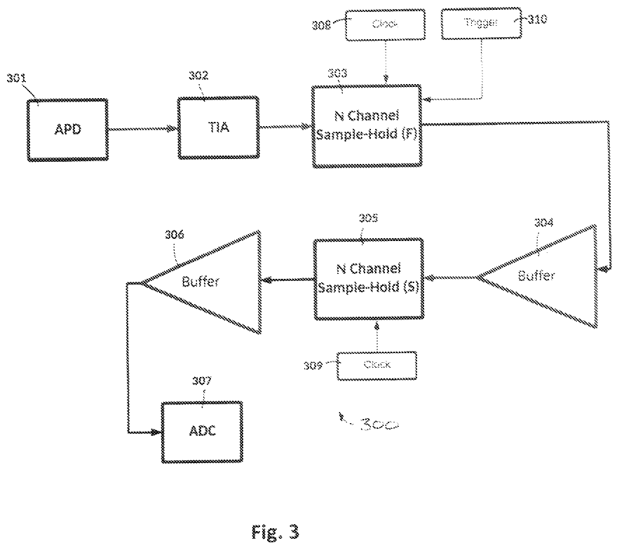

Referring now to the invention in more detail, in FIG. 3 there is shown a system 300 comprising a detector 301, e.g., avalanche photodiode (APD), that is connected to an amplifier 302, e.g., transimpedance amplifier (TIA), that converts a detector photocurrent to a voltage and produces output signals for an N-channel Sample and Hold (F) 303, e.g., N at least 1, where (F) denotes a fast sampling operation, e.g., nanosecond scale. The system further comprises a multi-channel, e.g., N channel, buffer 304 that produces signals at the input of a second N-channel Sample and Hold (S) 305, for which the (S) denotes a slow sampling operation, e.g., microsecond scale, and this sampler 305 is connected by a multi-channel buffer 306 to facilitate the subsequent digitization with a multi-channel, e.g., at least one channel, analog to digital converter, or ADC, 306 that produces digitized samples in accord with the signal input to the APD 301, e.g., a received laser pulse and the fast sampler 303 samples. For sampling processes 303, 305 there are clock signals 307, 308, respectively, that provide the sample timing and that occur at a predetermined frequency in accord with the desired fast and slow sample rates. It is understood that while the context for this description is a LiDAR system, e.g., one that processes light signals, the invention fundamentally requires only photons at its input detector and such photons could originate from any electromagnetic source of energy, e.g., RADAR (radio detection and ranging), and thus could be used in a variety of contexts with a suitable change of detector type. It is further understood that while only one additional stage of slow sampling 305 is shown, the process of resampling can be extended to additional stages such that alternate timing and data strategies could be exploited with the invention.

In more detail, still referring to FIG. 3, one purpose of the architecture of FIG. 3 is the production of full waveform data when high speed sampling is required and it is advantageous to realize the architecture in a single LiDAR pixel, one of a larger ensemble of pixels, e.g., a two-dimensional array of LiDAR pixels, without incurring the high physical area and heat dissipation burden associated with using many high-speed ADC (analog to digital converter) devices that typically occupy very large areas. The use of multi-stage sampling enables the use of relatively low capacitance sample and hold elements that are consequently fast without incurring the loss of signal that a low capacitance would produce, e.g., signal decay or “droop”, in the absence of a high-speed digitizer at each capacitor to immediately digitize signals. Sampling a second time creates the time needed to sample later without significant loss of signal.

In more detail, still referring to FIG. 3, the architecture of FIG. 3 is that of a single pixel in our exemplary full waveform flash LiDAR system. The ADC 306 is included in this diagram because, in the case N is small, e.g., N=1, a single ADC 306 would suffice and would be practicable. However, in the larger flash LiDAR context, the ADC 306 and/or additional functional elements, e.g., timing signals 207 208 would be shared amongst many pixels.

In more detail, still referring to the invention of FIG. 3, it is evident that one element of the illustrated embodiment is the multi-stage sampling used to reduce the digitizer bandwidth by progressively decreasing the signal decay time by virtue of storing signal samples on incrementally larger capacitors at each stage of sampling. This can be described as a sequence of rapid sampling, e.g., as a burst of samples, followed by a resampling and relatively slow digitizing and reading out of the sampled signal. This approach can be extended to accommodate continuous sampling if the temporal length of the samples and number of sampling stages is optimized for a given high speed sampling rate, e.g., the spacing and quantity of temporal samples in the first and fastest sampling stage would predetermine the structure necessary for continuous sampling.

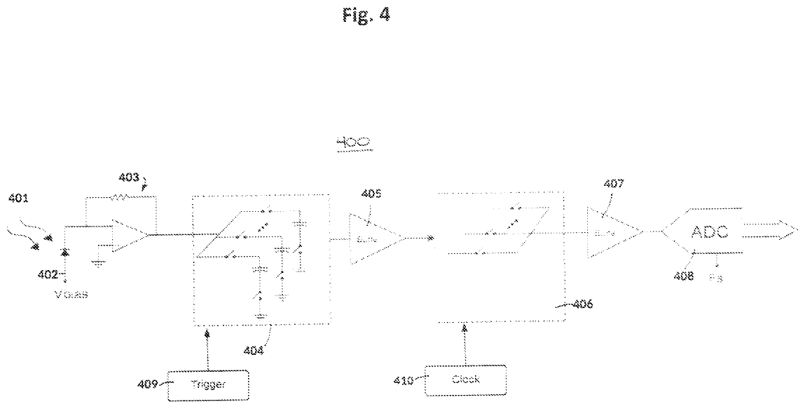

Referring now to the schematic 400 shown in FIG. 4, the signal 401, e.g., incident photons to be sampled and digitized, are shown entering the APD 402 illustrating its diode connectivity explicitly, e.g., its anode is connected to a bias voltage, Vbias, and its cathode is connected to the input of the TIA 403. The fast sample and hold elements 404 are illustrated more explicitly as switching devices that sample an input and store the sampled signal on capacitors that can be reset, e.g., with a switch connecting to ground, these samplers being buffered thereafter with a buffer 405 (summarized with a single amplifier symbol) that further connect to a sampler 406 similar to that of 404, this second sampler being connected to a digitizer, e.g., ADC, 408 by a buffer 407.

In both FIGS. 3 and 4, the Triggers 309 and 409 are used to start the process of sampling and subsequent digitizing of temporal signals 401 produced by the detector 301. This trigger can be provided externally or can be generated with a companion detector placed in proximity to each detector 301, e.g., a single photon APD (SPAD) could be used as a triggering device that responds to a water surface return (often this is the first significant return for an airborne marine LiDAR).

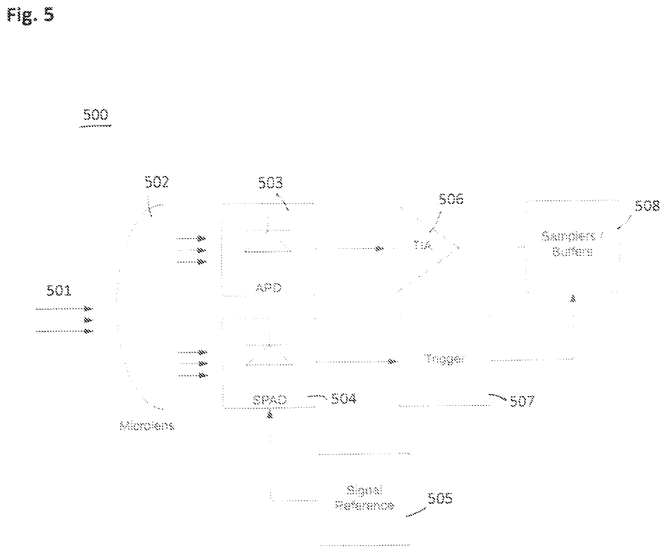

For example, referring now to FIG. 5, a detector is added to FIG. 4 in the region, e.g., focal plane, where the input signal 501 is applied through a microlens 502 (optional, but helpful) such that an input signal of a predetermined, or dynamically computed amplitude is detected (by way of comparison with a signal reference 505) with a SPAD 504 while APD 503 is simultaneously illuminated, the SPAD 504 signal being used to trigger 507 the full waveform sampling process 508 supported subsequently by way of clock signals injected into the samplers/buffers 508, in accord with the logic of FIG. 4.

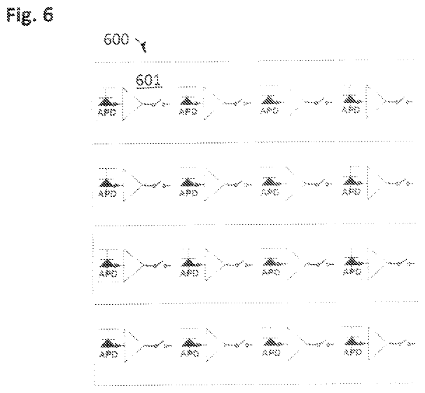

Referring now to FIG. 6 the single pixel 400 is extended, e.g., using the pixel element 601 to represent the single pixel 400 in compact form, to an array configuration 600 such that flash LiDAR data is attained with the full waveform for an illuminated region wherein a temporally structured light source, e.g., a laser pulse, is diverged from a beam or point source to produce a distribution of light that illuminates an area such that spatial resolution, e.g., picture elements (“pixels”), are enabled that correspond to the locations of pixels in the array of single pixels. The array configuration 600 shown is a rectangular distribution of pixels; however, arbitrary shape distributions, e.g., geometric or non-geometric, are contemplated in addition to lower density distributions such as lines and points or clusters of points separated by more than one pixel.

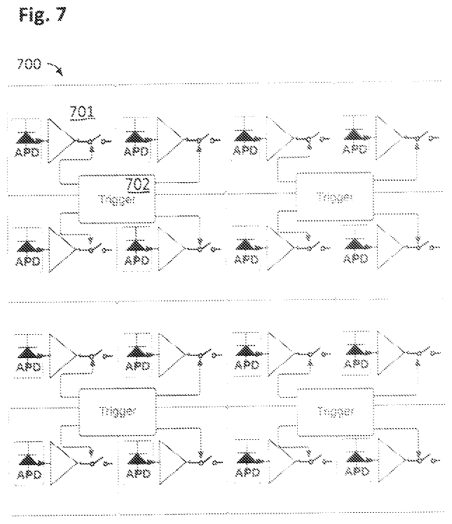

Referring now to FIG. 7, the array configuration of FIG. 6 is extended to include single photon avalanche photodiode Trigger (SPAD) regions 702, each region associated with one or more single pixel 400 regions (shown in compact form 701), such that flash LiDAR data can be obtained with simultaneous and independent first return and full waveform data, given that full waveform and first return pixel elements would be interleaved and may produce some under sampling of the scene, depending on the structure of the scene and the structure of the array configuration 700. In this configuration the Trigger 702 comprises SPAD detection components, e.g., 504 505 507, and may share a lens with adjacent APD pixels 701 or may have an optical element dedicated to its SPAD function; it is understood that the relevant sampling of the focal plane may require compensation akin to that used in digital color photography, e.g., the RGB Bayer pattern and associated image resampling algorithms.

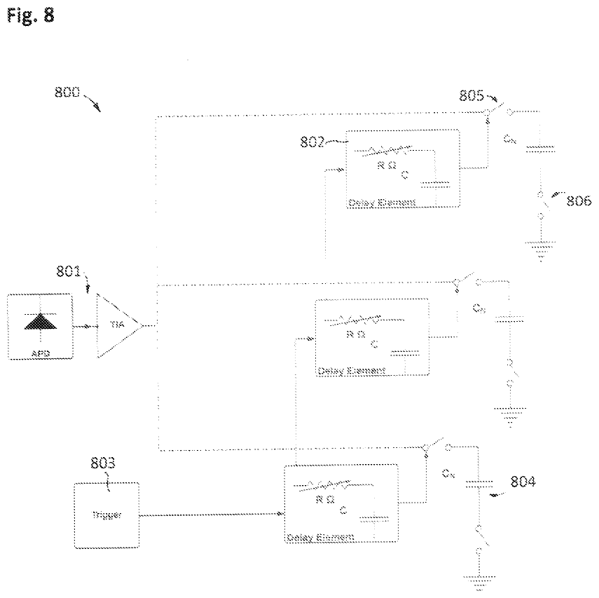

Referring now to FIG. 8, a conceptual schematic of a clocking 309 310 mechanism 800 is shown that takes signal input from a transimpedance amplified APD current 801 and samples the signal with sample capacitors Cn 804 using a sampling “switch” 805 (a transistor, in practice) that is delayed in time with respect to the trigger signal 803 which initiates a sequence of multiple, sequential samples of the signal input, each sample separated in time by a time delay element 802 that, as shown, uses an analog RC (resistor-capacitor) time decay phenomena to produce a delay, e.g., retriggerable. This delay is shown as an analog element but could also be implemented with digital elements for which a clocking signal is provided, e.g., if for example the Trigger 803 is replace with a pulse train comprising a time series of two-state (digital) voltages, either as a simple square wave or a variable width digital signals or pulses. This delay schematic produces a variable bin size for the LiDAR application such that sequential time samples can be separated by an arbitrary amount of time and the samples that result have a corresponding arbitrary integration time. As a result, should the first sample in a pixel be delayed arbitrarily with respect to a global trigger applied to the ensemble of LiDAR pixels, phenomena such as the curvature of the backscattered light field can be accommodated seamlessly.

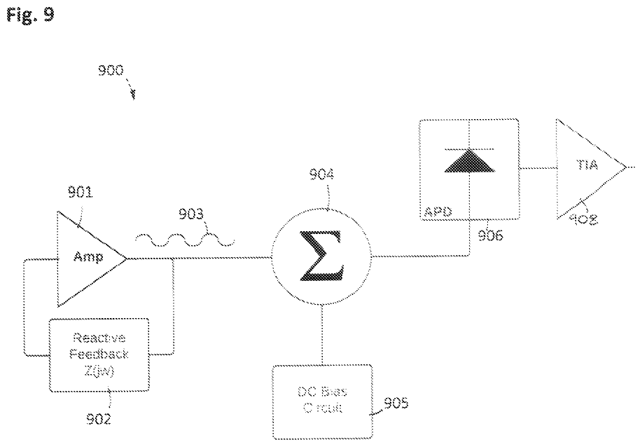

Referring now to FIG. 9, a system 900 is illustrated for modulating the gain of an APD by modulating its DC bias. In this illustration an oscillatory signal 903 is produced using an amplifier 901 with reactive feedback 902 such that a periodic waveform, e.g., a sinusoid, is produced for addition to a DC bias circuit output 905 using a summing junction 904 that outputs a biased periodic signal to the anode of an APD 906 so as to periodically modulate its gain. There are many ways to make use of this modulated gain. For instance, one could adjust the phase in the Reactive Feedback block to synchronize the gain with a decaying exponential LiDAR signal (such as one would encounter in scattering and absorbing media), or a phase locked loop could be used to lock onto the error signal with respect to a LiDAR scene feature, e.g., a scene surface, such that the gain opposes the decay of signal from that surface and beyond that surface, the purpose of the modulation being to compensate for a known behavior of the signal being received by the APD such that, for instance, a wider dynamic range scene can be observed. APD power supply modulation can also be used to modulate control signals onto the supply such that addressing and adjustment of individual pixels can be accomplished by single or “super” pixel elements (“super” referring to a grouping of pixels that share some common functions in order to economize the average size of a pixel in an array or ensemble of pixels).

In more detail, still referring to FIG. 9, if the amplifier with reactive feedback is replaced with an arbitrary waveform generator, one can produce amplifier waveforms that more fully correct for a scene decay function by using the output of the APD 906 and TIA 908 to observe the scene and modify its temporal behavior with a counterposed waveform 903 until its return approaches a DC level, for instance-this would constitute a “nulling” of a background exponential decay for this example.

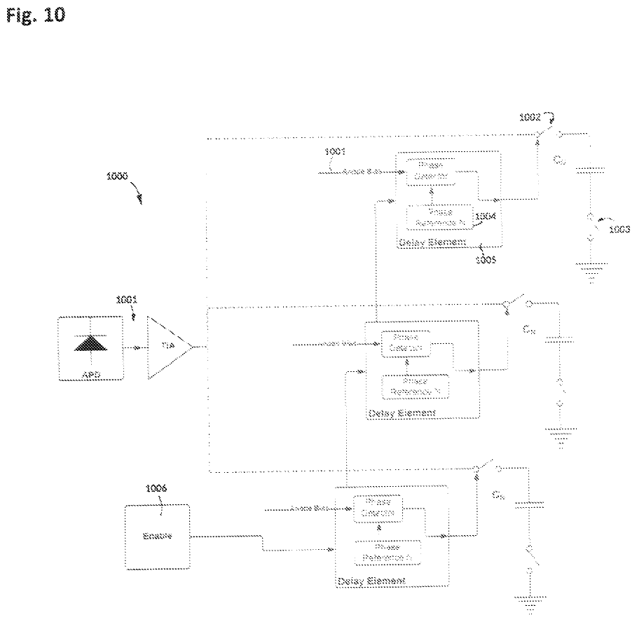

Referring now to FIG. 10, a clocking (or sample delay) mechanism 800 is modified 1000 to enable the use of a gain modulation 900 signal derived from the APD bias modulation, e.g., the periodic waveform at the APD anode, as a sampling “clock”. In this case a delay is produced by the advance of the phase of the periodic APD 1001 modulation 1001 waveform and each delay element 1005 has a programmable or fixed phase reference 1004 from which a phase detector generates a signal to drive a sampling switch 1002. As shown, an initial enable 1006 is used to start the sequence of phase detections, each Delay Element disabling itself and enabling its successor, and so on; each sample can, once sampling is complete, be reset 1003 to enable recurrence of the sample sequence. In this situation the first Enable signal plays a role similar to the Trigger 803 of the prior example.

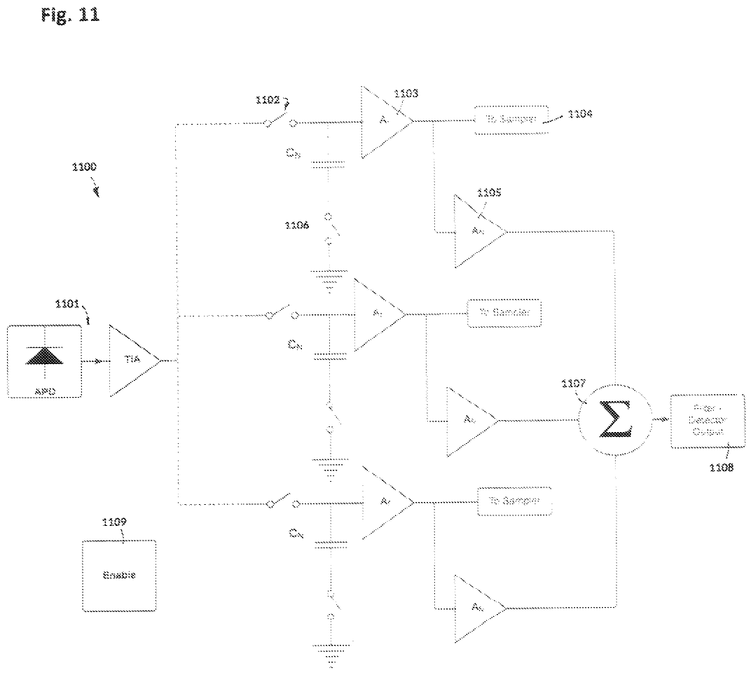

Referring now to FIG. 11, if a variable gain buffer A_n is added to each sample in the multi-channel sampler 303 a means of demodulation is produced 1100 for the time varying signal generated by the APD and TIA 1101. As shown, this demodulated signal is produced as the set of A_n 1105 sampled signals having an amplitude modulated character, by virtue of fixed gain A_f, 1103 with respect to the unmodulated set of sampled signals nominally forwarded “To Sampler” 1104. If, for instance, the modulated samples are summed 1107 to produce a filtered detector output, e.g., a filter-detector output 1108, a process akin to a matched filter detector can be produced. If, further, the A_n gains are permitted to varying with time, the demodulated output can be used as a time varying detector output that is used to detect signal features prior to the secondary sampling and subsequent digitization, e.g., in the case where, in addition to a sampled output of the sort generated by 300, a feature detector signal can be formed to use in controlling the LiDAR delay such as would be the case if the feature being detected is the water surface or some other scene reference point.

### Demodulation Techniques

Modulation is advantageous for enhanced ranging within a sample vector. Given the sampling of photonic signals traversing a LiDAR pixel of the invention, it is possible to use and interpret the samples in the same way any sampled waveform is used—either as a replica of the transmitted waveform that must be detected for the sake of assessing its round trip time, or as a waveform having an envelope, e.g., the Gaussian shape of a laser light emission, and a modulated signal contained with the envelope such that additional information can be obtained from the received light, e.g., enhanced range resolution or information about velocity (doppler shifts) in the case of a sinusoidal frequency modulated modulation.

### Gain Modulation Techniques

Compensating for gain is often helpful for correcting an a priori known signal decay, e.g., the exponential decay of absorbing and scattering media. In such a case it is possible to adjust the gain of the invention, e.g., using APD parameters, over time such that range related corrections can be made to the signal before digitizing. This use of gain modulation enables the use of faster and lower gain ADC devices, e.g., lower effective signal dynamic range, and simpler compute elements attached to the digital output of the invention. Varying gain of individual APD-TIA pairs is fraught with difficulty for stability and speed. However, if the bias of the APD is modulated, e.g., as a sinusoid, linear gain moves can be obtained in the pseud-linear portion of the sinusoid and nonlinear gain movements can be obtained near peaks and valleys. If the amplitude, phase, and frequency of the sinusoid is synchronized with the decay of the return signal from decay-inducing media, then the gain can be used to compensate for signal loss such that simpler, less demanding signals are obtained at the invention output. For example, if an L-C “tank circuit” (the APD bias circuit being part of the “C” and “L”) for resonant modulation at MHz frequencies is used, ns-slope-scale sinusoids are possible.

Gain modulation of this sort can also be shaped to the medium using feedback, recognizing, for example, that exponential decay is characteristic of propagation of energy through turbid media and that summed complex exponentials comprise sinusoidal functions, decay can be compensated with sinusoidal gain modulation by selectively synchronizing decay features with sinusoidal features. Those skilled in the art of signal construction will also be able to construct periodic signals that replicate arbitrary waveforms, e.g., the commercial arbitrary waveform generator is a well-known device.

Gain modulation can also differ as a function of location in an array context such that the varying character of the pixels within a flash LiDAR region are accommodated, e.g., for managing the gain timing changes due to time-of-flight curvature.

Gain modulation can be phase locked to signal references derived from the observed environment, e.g., the sampled character of the particular water volume being imaged, from an internal reference or clock, or an external, companion sensor that provides scene-relevant information to support synchrony to scene features. For example, one could phase lock a separate marine lidar, e.g., single pixel FMCW device, to the internally modulated waveform to track a water surface or a similar approach could enable bottom following for shallow water or surf zone, as the returns from the bottom in shallow water are often stronger than that of the surface.

### Burst Mode Digitization

Various embodiments of the present invention include multi-stage sampling used to reduce the digitizer bandwidth by progressively decreasing the signal decay time by virtue of storing signal samples on incrementally larger capacitors at each stage of sampling. This can be described as a sequence of rapid sampling, e.g., as a burst of samples, followed by a resampling and relatively slow digitizing and reading out of the sampled signal. This approach can be extended to accommodate continuous sampling if the temporal length of the samples and number of sampling stages is optimized for a given high speed sampling rate, e.g., the spacing and quantity of temporal samples in the first and fastest sampling stage would predetermine the structure necessary for continuous sampling.

### Signal Compression

Signal compression can be supported in at least two ways: 1) an analog equivalent to a run length encoding in which samples are not “spent” unless signals change by a predetermined minimum amount, which case sampling occurs and a reference clock is registered in proportion to the integral of a reference voltage used to accumulate, e.g., count, elapsed time; 2) allowing nonlinearities in signal extrema, e.g., the “elbow” of a transistor amplifier gain response, or using variable gain to reduce dynamic range by varying the gain applied to the signal source to be sampled such that the gain optimally compensates a predetermined or measured temporal response, e.g., an exponential decay of a medium caused by scattering or absorption, in the case of a photonic signal source that is typical of LiDAR technologies.

### Variable Range Sampling of a Space

It is often the case that much of a scene being observed or imaged remains unchanged over time, but that only limited portions are changed. In this case, in order to optimize the tradeoff between sample density and available time, embodiments of the present invention contemplate the variation of the distribution of temporal samples as a function of range and spatial location within a flash LiDAR image such that optimal resolution can be obtained for apparently fixed objects by having a few high density samples located at object edges, and coarser temporal resolution, e.g., wider range bins, can be used for apparently unoccupied regions of range (distance). This permits the use of successive illumination events, e.g., laser pulses, to adjust the density of temporal samples per region imaged; the gain may also be adjusted as a function of range, in order to compensate for distance when, for instance, the medium being interrogated with the LiDAR sensor introduces attenuation or divergence of the illumination. By optimizing the temporal gain profile, various embodiments of the invention can be used to produce a form of a priori range compression of 3d datasets while they are being constituted by a 3d sensing system such as can be produced with the invention.

### Matched Filter Sampling of a Volume

An extension of the variable range sampling of a space is the use of sample density in all three spatial dimensions to precondition the detection of objects having a predetermined spatial extent; this can be combined with gain to produce arbitrary 3D volumes which, when imposed systematically on a space being explored, e.g., a room or container being scanned, generate a signal, e.g., upon integrating the sampled charge, that represents the likelihood of the object being searched for.

### Analog Memory and Neural Signals

In some embodiments, the volumetric sampling, if viewed as a network of neurons, can be used to inform synthetic neural synapses, e.g., trained on representative digital data, so as to bypass the digitization and recomputing, yet enable signaling and interpreting of 3d data very compactly. For instance, one may wish to connect the analog domain signals produced with the invention to enable three-dimensional sensing and interpretation by an artificial intelligence (AI) model, e.g., one of the large language learning models (LLMs) presently in use.

To connect multiple temporal samples per pixel of a flash LiDAR FPA to the fabric of an AI model without the complexity associated with traditional computing models like the Von Neumann architecture, we can leverage neuromorphic computing principles and techniques. Neuromorphic computing aims to emulate the brain's structure and operation, which inherently deals with massive parallelism and efficient information processing.

For example, one general approach is to use event-based processing (EBP) in combination with spiking neural networks (SNN) and temporal convolutional networks (TCNN). For EBP, rather than processing images frame by frame, we can adopt an event-based processing paradigm. In this paradigm, the sensor outputs events (changes in intensity or depth) asynchronously, allowing for low-latency processing and efficient use of computational resources.

SNNs are a class of artificial neural networks that mimic the behavior of biological neurons. They communicate through spikes (action potentials), enabling efficient processing of temporal data. In this approach, each event from the LiDAR FPA can be considered as a spike in the neural network.

TCNs are neural networks specifically designed for processing sequential data. They have shown promising results in various temporal tasks and can be well-suited for processing the temporal dimension of LiDAR data.

Continuing with the foregoing example, a specific instantiation of an interface design to connect the invention to an AI model is to encode pre-determined events using analog or mixed digital/analog signals. In using event encoding each event from the LiDAR FPA can be encoded into a format that can be understood by the SNN. This encoding may involve representing the event as a spike with attributes such as time, intensity, and spatial location. Since for our example the AI model will consist of layers of spiking neurons, these neurons will receive the encoded events from the LiDAR FPA and process them through synaptic connections. The architecture of the SNN can be customized based on the specific task the AI model is designed for. Finally, within the SNN, TCN layers can be incorporated to capture temporal dependencies in the LiDAR data. These layers will perform convolutions over the spike trains to extract features relevant to the task.

Finally, to complete the example with the integration with downstream processing, the output from the SNN can be further processed by conventional neural network layers or other modules depending on the application. For example, if the goal is object recognition, additional layers for classification can be added. By implementing this approach, we can achieve efficient processing of 3D LiDAR data within an AI model without the need for traditional computing models. The architecture is inherently parallel and suited for real-time processing, making it ideal for applications such as autonomous vehicles, robotics, and augmented reality.

### Infrared Ranging Radiometer

If embodiments of the invention are mapped to a semiconductor process that is amenable to either a monolithic form (photonic devices in same substrate as sampling and digitizing structures) or a multichip module, e.g., a detector array in combination with a readout integrated circuit (ROIC), one can combine radiometric (receiving the signals emitted by the environment) and LiDAR (receiving signals emitted by the invention equipped with a signal source or transmitter) modes of operation such that both reflectivity and emissivity of imaged objects can be determined, e.g., if the signal strength and scene geometry can be approximated to some predetermined fidelity. This is useful for interpreting thermographic data, for instance, to indicate the physical temperature of objects.

### FPA With Micro Apertures for ROIC

Given a microlens that assists with light focusing on a per-pixel or per-group-of-pixels basis, light can be focused onto an array of detector elements, e.g., a two-dimensional row-column array of avalanche photodiodes (APDs), constituting a frequent use of microlens devices to improve the quantum efficiency of an APD array. With an adjustment of the microlens design, it is possible to focus light at a point that is in a plane beyond the APD array, e.g., a plane behind the APD array, a second plane that is on a side of the APD array opposite the APD array. If, further, the second plane contains not only some electronics, e.g., per pixel and per array, but also some photodiodes, these photodiodes can be illuminated with the adjusted microlens such that, if an aperture is created in the first plane, that of the APD array, then the detectors in the second plane can be located at the focus of the adjusted microlens, e.g., its focus being through the APD array and onto the second plane where additional photodiodes are arrayed at the foci of microlens-aperture pairs. In this way, one wavelength of light could be detected in the first plane, the APD array, and a second wavelength of light could be detected with an array on the second plane, thereby producing a form of multi-wavelength image using two arrays of detectors placed one behind the other. This can be extended to the limit of the available scale for photodiodes, e.g., APD or non-APD, and the permissible number of apertures, e.g., for mechanical integrity and the limits of active area for the photodiode and process being used. It is possible to also extend this to many planes, again within the limit of the optical materials and microlens complexity a given structure will support, e.g., an optic resembling a microlens collimator may be required, and this will carry with it some complexity and cost that could lie beyond practical design for some applications. However, the invention does contemplate the use of multiple planes with apertures in one or more upper planes that, when combined with microlens elements having a focal length compatible with the distance to the detector, e.g., in planes at increasing distance from the lens, produces additional spectra at interleaved locations. This would for instance allow for the production of RGB 3D imagery.

For a multi-planar set of detector arrays it is also possible to use the size and shape of the aperture in the plane passing microlens-focused light onto a next plane to effect spatial shaping or focus-filtering (Fourier optics) of the light passing through the aperture, thereby providing a spatial filter; using a similar approach, polarimetry can be enabled.

Finally, for the multi-planar array assembly, if light emitters are paired with light detectors, e.g., APDs, a photonic wavelength conversion could be accomplished such that the nominal bandwidth limitations and wavelength limitations of semiconductor substrates and multi-chip interconnections could be mitigated.

### Modulation for Enhanced Ranging Within a Sample Vector

Given the sampling of photonic signals traversing a LiDAR pixel of the present invention, it is possible to use and interpret the samples in the same way any sampled waveform is used—either as a replica of the transmitted waveform that must be detected for the sake of assessing its round trip time, or as a waveform having an envelope, e.g., the Gaussian shape of a laser light emission, and a modulated signal contained with the envelope such that additional information can be obtained from the received light, e.g., enhanced range resolution or information about velocity (doppler shifts) in the case of a sinusoidal frequency modulated modulation.

### Successive Approximation Ranging

In accordance with various embodiments, ADC techniques may be applied at the application level for range to digital conversion (RDC). Given the ability to estimate range by “finding” the return of a laser pulse in the temporal evolution of a received LiDAR transmission, the invention also contemplates the use of such a detected return pulse as a first estimate in several successively more accurate estimates of range. This again involves the use of a demodulation device, such demodulation being accomplished in the use of the samples it generates. To successively improve the estimate of range to an object or surface, the variable bin size of the invention is used to refine the range resolution over many pulses to the limit of range resolution for a particular instantiation of the invention in semiconductor form. Additional range resolution can be obtained, when the signal is of sufficient quality, by modulating and demodulating signals within the sample temporal range of the invention, where adjustments to triggering and delaying of the sampling process are controlled within the invention or separately. This would permit “coherent” detection methods, e.g., I-Q demodulation, which may enable more granularity of temporal measurement than the interval-detection that characteristically can only locate to within one half sample time.

### Gain Modulation Using the Substrate or Anode

Compensating for gain is often helpful for correcting an a priori known signal decay, e.g., the exponential decay of absorbing and scattering media. In such a case it is possible to adjust the gain of the invention, e.g., using APD parameters, over time such that range related corrections can be made to the signal before digitizing. This use of gain modulation enables the use of faster and lower gain ADC devices, e.g., lower effective signal dynamic range, and also simpler compute elements attached to the digital output of the invention. Varying gain of individual APD-TIA pairs is fraught with difficulty for stability and also speed. However, if the bias of the APD is modulated, e.g., as a sinusoid, linear gain moves can be obtained in the pseud-linear portion of the sinusoid and nonlinear gain movements can be obtained near peaks and valleys. If the amplitude, phase and frequency of the sinusoid is synchronized with the decay of the return signal from decay-inducing media, then the gain can be used to compensate for signal loss such that simpler, less demanding signals are obtained at the invention output. For example, if an L-C tank circuit (the APD bias circuit being part of the “C” and “L”) for resonant modulation at MHz frequencies is used, ns-slope-scale sinusoids are possible.

### Thermal Plus Range for Recognition

One of the challenges in human recognition using facial features with machine vision is the superficial nature of two-dimensional imagery—it is a projection of one's face reflectivity onto a particular spectral range, e.g., 400-900 nm in the case of CMOS focal plane arrays. Consequently, it is likely that two people look alike when there are obscurations of underlying face features, e.g., sunglasses that hide the eyes and prevent detection of pupil geometry (a common discriminant). In such cases, and when two people really do have comparable fundamental features, it is helpful to have additional information. One of these is topography of the face—3D imagery of the face. Another is additional spectra, e.g., short wave infrared (IR), mid wave IR or long wave IR. The invention is helpful in such cases by permitting the combination of 3D and 2D data in a single, e.g., monolithic, device by virtue of having standalone pixels of both types dispersed throughout a focal plane array, or by having groupings, e.g., mini-arrays of CMOS visible light photodiodes, interspersed with LiDAR pixels equipped with APDs—such a scheme can work because it is often the case that less resolution is required for useful topography than it is for useful geography, to use a cartographic metaphor. In this case the use of a different microlens for each type of detector can achieve complete coverage of a field of view without producing gaps in scene coverage. If this is combined with a multilayer aperture-in-focal-plane-array approach, a combined 3D and 2D image could be obtained in one waveband, e.g., 400-900 nm that CMOS would readily enable, and thermal infrared could be added, noting of course that more detectors implies a change in scene sample density, and also that thermal infrared microlens devices would be needed having different material properties. If the thermal infrared pixel is a LiDAR pixel, then it could be used for both passive and active imaging, adding a 4^{th} data type to this example.

### Modulation of Control Signals onto a Device Bias

One of the complications of IC design for detector arrays is the routing of control signals. However, if pixel size or greater regions are equipped with logic, e.g., state machine or serial register, etc., or suitable analog detection circuitry, e.g., of the analog computer sort, then the requisite bias voltage for photodiodes can be used for signaling. Given the capacitance of the bias circuit, this would likely be lower frequency, e.g., “audio” band signals, but this would nonetheless permit much data to be communicated across one or more ICs such that fewer signal “wires” would be needed in an IC design. This is a tradeoff, it is clear, between the complexity of a pixel or pixel group (i.e., if the communication logic is carried for a group of pixels or super pixel) and the complexity of an entire array.

### Variable Sample Capacitance and Adaptive Sampling

Various embodiments of the present invention include sampler design and/or operation to modify the APD-TIA detector electronics. The high-speed sampler that follows immediately after the APD-TIA pair is known to “load” the pair such that noise, gain and bandwidth are affected. By selecting capacitance and timing values strategically, it is possible optimize the use of IC area (“real estate”) for a known temporal response such that dynamic range is matched to the sample range, input referred noise is optimized for small signals, kTC noise is well matched with signal amplitudes and bandwidth is maximized where it is beneficial to do so. Further, if sampling capacitors can be well timed for connect-disconnect, the capacitive loading of the TIA can be managed.

### Pixel Based Delay Timing

If each pixel in the LiDAR pixel has independent sampling timing, and if sample times can be varied across the ensemble of samples for a given pixel, then it is possible to compensate for time of flight or geometrical biases introduced by virtue of the “curvature” of the speed of light as a function of angular position across a LiDAR focal plane array with a lens attached, for instance. It is also possible to use this same capacity of pixel timing to vary the density of samples in time so that LiDAR receiver signals can be sampled coarsely or finely as appropriate.

### Biological Applications

Given the capacity to time resolve electromagnetic energy, e.g., light phenomena, the present invention can be applied to a marine detection field where the marine environment is the water-dominated environment of an organism, e.g., human, animal, or plant biological matter. One or more pixels of the invention can, in such a scenario, be used to measure the temporal fluorescence response of the biological sample at one or more excitation wavelengths, the wavelength variation occurring by means of source or detector wavelength variation (or both). In so doing, the sample may be characterized for its inherent properties, e.g., fluid chemistry, cellular construction or constituents, or those of an added constituent, e.g., marker.

The use of the invention in such a biological application is readily applied to static situations such as microscopy, in which the spatial, fluorescent, temporal and temporo-spatial-fluorescent behavior of observed samples can be quantified and used to identify and characterize constituents. Given the compact nature of the preferred embodiment of the invention, it is also readily used in body-wearable devices for transcutaneous or even in-vivo measurement of biologically relevant parameters having to do with the health and status of biological media.

Some applications and algorithmic processing for the benefit of patients are described here. In one embodiment, the invention contemplates blood constituent monitoring. In this case the invention could measure the fluorescence lifetimes of blood constituents, providing real-time insights into oxygen levels, hemoglobin concentration, and other vital parameters. The algorithm could process this data to generate dynamic profiles, alerting healthcare providers to changes and enabling personalized interventions for conditions such as hypoxia or anemia.

In another embodiment, tissue oxygenation assessments could be made. By analyzing fluorescence lifetimes in tissues, the invention could assess oxygenation levels. An algorithm could translate this information into a continuous oxygenation map, aiding in the early detection of compromised tissue perfusion and guiding interventions for conditions like ischemia.

In another embodiment of the invention for biological measurements, drug metabolism monitoring could be supported. In this use case, the invention could be utilized to monitor the metabolism of drugs in real time. An algorithm could analyze fluorescence lifetime changes induced by drug interactions, offering valuable data for optimizing medication regimens and minimizing adverse effects.

In a further embodiment of the invention, fluid composition analysis could be supported. In this context of fluid analysis, the invention could assess the composition of bodily fluids, detecting variations in glucose levels, electrolytes, and other biochemical markers. And algorithm could provide actionable insights for patients managing conditions such as diabetes or electrolyte imbalances.

In a further embodiment, the invention could support wound healing monitoring. By applying the invention to wounds or surgical sites, it could monitor the fluorescence lifetimes of tissues during the healing process. An algorithm could generate a healing trajectory, enabling timely interventions for complications and optimizing postoperative care.

For each of the embodiment examples provided, an algorithm for processing data can be constructed using the following workflow, such that actionable insights for patients and healthcare providers are produced.
1. Data Preprocessing: Calibration of device for accurate measurements accompanied by noise reduction and signal enhancement.
2. Parameter Extraction: Extract fluorescence lifetime data for relevant biomarkers, correlate fluorescence lifetimes with specific physiological parameters (e.g., oxygen levels, glucose concentrations).
3. Dynamic Profiling: establish dynamic profiles for monitored parameters. Detect deviations from baseline values.
4. Threshold Alerts: set personalized threshold values based on individual patient profiles, trigger alerts for significant deviations indicating potential health concerns.
5. Expose data products in a user-friendly interface: instantiate a user interface for patients and healthcare providers, display real-time and historical data trends.
6. Integration with Embedded Computer: ensure seamless integration with embedded computers for on-the-fly processing, facilitate data transmission to centralized healthcare systems for remote monitoring.
7. Machine Learning Integration in order to automate and support optimization: Implement machine learning algorithms for adaptive learning, enhance predictive capabilities for anticipating health trends.

By combining the device's capabilities with a sophisticated algorithm, such as that outlined here, patients can actively participate in monitoring their health, and healthcare providers can receive timely, actionable data for informed decision-making, ultimately leading to personalized and proactive healthcare interventions.

Examples of biological targets to assess with the invention are provided here as examples having valuable outcomes. Targets examples for blood constituents with Fluorescence Lifetime Imaging (FLIM) for example, include Oxygen Saturation (O2) using near-infrared (NIR) wavelengths (700-900 nm) for optimal penetration. The short pulses on the order of picoseconds would be required to capture rapid oxygenation changes with, temporal resolution also on the order of picoseconds for capturing fast dynamics. For this constituent, the expected Fluorescence waveform would capture the quenching of fluorescence with oxygen binding, leading to a decrease in fluorescence lifetime.

Another constituent that can be considered is Hemoglobin (Hb) concentration, measured in the visible wavelengths (500-600 nm) for sensitivity to hemoglobin absorption. Short nanosecond or shorter pulses to differentiate between oxy-and deoxyhemoglobin assessed with moderate temporal resolution (nanoseconds) would support assessing hemoglobin concentration changes. Here the variations in fluorescence lifetime would track with changes in hemoglobin concentration.

An additional constituent of interest is glucose, measurable in the ultraviolet (UV) or visible range (300-500 nm) for glucose sensitivity. Short pulses, nanoseconds or less would be expected here, with resolution greater than the pulse widths used, with fluorescence lifetimes expected to vary in some proportion to the glucose levels.

The measurement of other constituents of interest many of which can be assessed in the UV and visible range with criteria similar glucose, includes the following: lactate, pH, electrolytes (e.g., Na+, K+), bilirubin, cholesterol C-reactive protein (CRP), white blood cell count (WBC)

These constituents are examples of applications contemplated for biological or medical applications of the inventions. It is understood that releasable products would require empirical testing and validation. The choice of fluorophores, wavelengths, pulse widths, and temporal resolutions would depend on the specific characteristics of the fluorophores associated with each blood constituent. Additionally, advancements in FLIM technology and fluorophore development may further refine these criteria.

### Industrial Applications

In a similar fashion to that of biological applications, fluids relevant to industrial markets can be observed for fluorescent behavior to characterize the fluid state and constitution, e.g., observing the character of petroleum products in storage or in transit via piping, or observing the integrity of transformer oil in electrical transformers used in electricity transmission and distribution, to anticipate and avoid transformer catastrophic failure. The invention is also readily applied to industrial monitoring situations where the fluorescent media is gaseous, e.g., a pollutant or combustion product that can be monitored for safety or process optimization.

The use of the present invention can also be extended to measurements that are not traditionally associated with LiDAR or temporal resolution. For noncontact industrial measurement applications, e.g., switchgear, it is useful to be able to measure the electric field intensity to assess the line voltage. It is known that APD and SiPM devices are able to sense electric field amplitude; consequently the invention pixel design can be used as an E field measurement device in addition to providing range information about the geometry of the objects producing and proximate to the sensed field, the invention yielding valuable spatio-temporal data that can be used to accurately map the electric fields and distinguish between their sources, e.g., the phases of a multi-phase electricity distribution asset.

### Additional Advantageous Embodiments

To optimize signal to noise ratio the invention envisions the use of correlated double sampling (CDS, a body of techniques well known to those skilled in the art) in the sample and hold process such that sampler storage elements can be “spent” on sampling at frequencies higher than the noise spectra to be reduced or eliminated, so that resultant correct samples have lower noise.

The invention also includes embodiments of algorithms for modulating gain adaptively with respect to medium absorption and scattering so that, for example, diffuse attenuation of the water medium (“k”), can be compensated over time through feedback (from scattering measurements made with time resolved data) and control (of gain modulation shape, slope, or intensity, etc.).

The invention further envisions embodiments using algorithms for successive approximation of object distance, an “RDC” (range to digital converter) using variable delay, one or more pulses, or a pulse modulated signal that enables synoptic coarse and fine range resolution of objects at some distance from the RDC device, e.g., readily conceived as a single pixel device included in other focal plane arrays to provide a 3d reference in an otherwise 2d “field” of data.

What is claimed is:

1. A method for obtaining terrestrial LiDAR data comprising:
providing a LiDAR system moving traverse to a ground canopy;
emitting light pulses from the LiDAR system toward the ground canopy and terrain such that the light pulses reflect therefrom;
receiving the reflected light pulses at the LiDAR system;
wherein the LiDAR system includes a monolithic module comprising a photonic device, a sampling module, a digitizing module, and a readout integrated circuit (ROIC).

2. The method of claim 1, further including a microlens that assists the LiDAR system with light focusing on a per-pixel or per-group-of-pixel basis such that light can be focused onto an array of detector elements.

3. The method of claim 1, further including performing successive approximation ranging.

4. The method of claim 1, further including performing gain modulation.

5. The method of claim 1, wherein the LiDAR system implements at least one of: pencil beam LiDAR, fan-beam LiDAR, and full-waveform flash LiDAR.
